(19) United States
(12) Patent Application Publication
(10) Pub. No.: US 2005/0022826 A1
(43) Pub. Date: Feb. 3, 2005

(54) Giving birth and movement(swaying, shaking)

(76) Inventor: Naum Ruvinskiy, Los Angeles, CA (US)

Correspondence Address: Naum Ruvinskiy;apt#1, 1232 N. Orange Grove ave., Los Angeles, CA, 90046, US

(21) Appl. No.: 10/632,200

(22) Filed: Jul. 30, 2003

(51) Int. Cl. A61H 23/00

(52) U.S. Cl. 128/898

(57) ABSTRACT

My invention is the description of how the movement of a woman giving birth such as swaying or shaking with the assistance of the such tools as vibrating chair or table often used by chiropractors can make the delivery easier and less painful as well as avoid medical intervention.

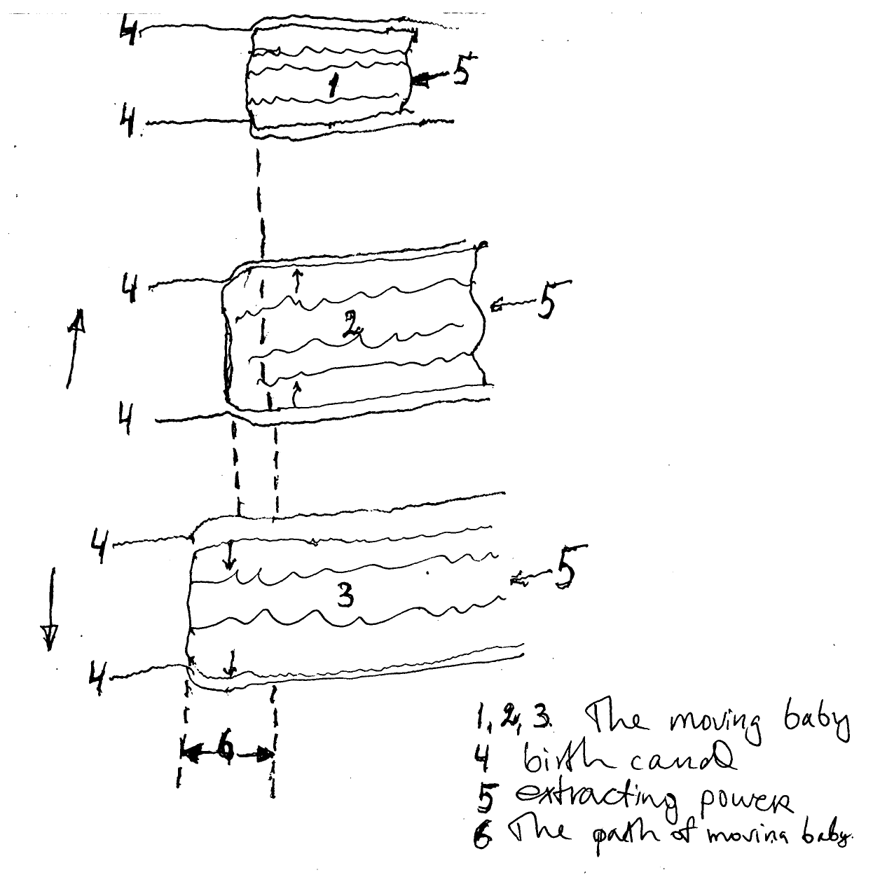

Provoking birth by means of medication when the woman is having hard time giving birth naturally is a known and common practice in the United States. However, the usage of drugs to induce birth can leave a negative effect on the baby as well as the mother. The goal is to help give birth by natural means. The goal is achieved by having the mother move/vibrate, such as sway or shake. This way the diameter of the birth canal will dilate and the uterus will move and move the baby, thus the child would come out due to inertia. The swaying or shaking of the mother can be performed by the means of swaying arm-chair, massager, lower abdominal and lower back massage. The birth can be performed on a train or in a cart. Also chiropractors have vibrating chairs and tables that can be used also. The length, speed and amplitude can be regulated by the mother. The movements of the mother will increase the diameter of the birth canal and decrease the tension. This method is really important in order to promote natural birth. This method makes surgical operation unnecessary, saves money on the cost of medication and shortens the delivery time.

Formula: the movement of the woman giving birth (vibrating such as swaying or shaking).

1. What I claim as my invention is “The movement of a woman giving birth”. My invention is in the field of medicine.
